(19) United States
(12) Patent Application Publication
(10) Pub. No.: US 2016/0238867 A1
(43) Pub. Date: Aug. 18, 2016

(54) DEHYDRATION METHOD FOR LIQUID CRYSTAL DISPLAY

(71) Applicant: SHENZHEN CHINA STAR OPTOELECTRONICS TECHNOLOGY CO., LTD., Shenzhen, Guangdong (CN)

(72) Inventors: Liang XU, Shenzhen, Guangdong (CN); Dong YE, Shenzhen, Guangdong (CN)

(21) Appl. No.: 14/131,266

(22) PCT Filed: Nov. 20, 2013
(86) PCT No.: PCT/CN2013/087482

§ 371 Date: Jan. 7, 2014

(30) Foreign Application Priority Data
Sep. 23, 2013 (CN) 201310437084.0

(51) Int. Cl. G02F 1/1341; C09K 19/00

(52) U.S. Cl. CPC G02F 1/1341; C09K 19/00; G02F 2001/13415

(57) ABSTRACT

A dehydration method for liquid crystal display comprises the steps: Step 1) leading the liquid crystal into a closed container filling with desiccant, desiccant directly contacting to the liquid crystal, the water could be absorbed by desiccant to keep the moisture content below 25 ppm; Step 2) leading the dried liquid crystal into a filter to insulate the large size pellets off; Step 3) deaerating the filtered liquid crystal in the vacuum; Step 4) leading the deaerated liquid crystal into an infusion equipment, and then pouringing them onto a base. The desiccant could fast absorb the water with directly contacting with the liquid crystal. The drying way is replayed by the directly contacting way to absorb the water in the liquid crystal effectually and improve the dehydration effectively. Not only get a steady Gamma value but also reduce the difference between the gray scale transition and the normal level.

### FIELD OF THE INVENTION

The present invention relates to the dehydration method for liquid crystal display directly contacting to the desiccative.

### BACKGROUND OF THE INVENTION

With the demand of the image quality improving, the manufacturers are searching for a better solve method to improve the image quality of the liquid crystal. The factors affected on the image quality are Gamma value, color numbers, the contrast, the luminance and the respond velocity and so on. Therein, the Gamma is root from the CRT response curve. That is, the Gamma is a parameter which is characterized as a nonlinear curve between the picture brightness of the teletron and the voltage of the input electron gun.

On the CRT display, the electron beam emitted from the input electron gun and that picture brightness is not linear variety with the input voltage of the teletron. The electron flow is change with the input voltage according to an exponential proportion. The exponential of the input voltage is large than that of the electron beam, so the signal in the dark space is darker than the actual, and the signal in the brightness space is higher than the actual. The luminance response is a nonlinear curve. For scale the nonlinear, the Gamma is used to confirm the relationship between the input voltage and the output voltage. The Gamma is a power function: the output voltage=the input voltagegamma. The transmission voltage curve is nonlinear. On the liquid crystal display, the Gamma is delimiting as

$${L}_{i} = {( \frac{i}{I} )}^{Gamma} ,$$

Wherein, Li is the luminance on the “i” Gamma (after normalization), “i” is a gray scale and “I” is the total gray scale. The “I” is to be 256 usually. When the Gamma value is larger than 1, then the stride across of the luminance on the high part is larger and that of on the dark part is smaller. On the contrary, if the Gamma value is less than 1, the stride across of the luminance on the dark part is larger and that of on the high part is smaller.

The Gamma value is a constant value on a liquid crystal display. There are a group Gamma voltages. The group Gamma voltages are delimiting the voltage on each gamma panel point. To a liquid crystal display, the curve of the voltage vs the transmission voltage is relative steady. So the Gamma of the liquid crystal display can be steady. The Gamma is to be 2.2 on a general liquid crystal display. The allowable wave scope is ±0.2. On the large scale manufacture, there are a lot of factors affect to the Gamma value, which comprising the batch difference of each material, alignment differences, the voltage of the thin film transistor and the current features and so on. Because of these factors, each Gamma of the liquid crystal display is difference. If the control on producing is not good, the difference will be amplified and exceeded the normally wave scope. If the deviation of Gamma is larger, there is a difference appearing on the gray scale transition stage or the normal showing stage.

During the manufacturing process of the existing liquid crystal display, the liquid crystal can be constantly absorbed the water around it after spreading. In the deaerating process, the air solved in the liquid crystal can be wiped out off, but the water is difficult to wide off. If the water remains in the liquid crystal, the liquid crystal will be cracking and make the life of the liquid crystal display reduced. In addition, the water will change the dielectric constant of the liquid crystal and influence on the curve of the voltage vs the transmission voltage. The curve could be steady in a liquid crystal display with a differential thickness.

Therefore, it is necessary to provide a dehydration method for effective reducing the moisture content in the liquid crystal and then achieving a steady Gamma value.

### SUMMARY OF THE INVENTION

To solve the disadvantage of the prior art, the main purpose of the present invention is provided a dehydration method for liquid crystal display with high drying efficiency and good effect in debase the water in the liquid crystal, so as to achieve a steady Gamma value of the liquid crystal.

The present invention provides a dehydration method for liquid crystal display, wherein comprising the following steps:

Step 1) leading the liquid crystal into a closed container which filling with desiccant, with desiccant directly contacting to the liquid crystal, the water in the liquid crystal could be absorbed by desiccant to keep the moisture content in the liquid crystal below 25 ppm;

Step 2) leading the dried liquid crystal into a filter to filter and insulate the large size pellets off;

Step 3) deaerating the filtered liquid crystal in the vacuum;

Step 4) leading the deaerated liquid crystal into an infusion equipment, and then pouringing them onto a base by ODF technology.

Preferably, in step 1) the desiccant is selected of zeolite molecular sieve or silica gel. In the closely container, with desiccant directly contacting to the liquid crystal, the water in the liquid crystal could be absorbed by desiccant.

Preferably, the method further comprises step A) before step 1) pretreating the desiccant below 200° C. for 4-5 hours and then cooling it to room temperature. With the pretreating on the desiccant, the drying efficiency could be greatly raised.

Preferably, the liquid crystal can be dried in the closed container for 8-12 hours. Compared to the traditional drying process, the drying time could be greatly reduced. The diameter of the filer hole is 1-5 μm. On the liquid crystal deaerating process, the temperature is 18-27° C. and the deaerating time is 0.5-4 hours.

Compared to the prior art, the dehydration method for liquid crystal display of the present invention, the desiccant could fast absorb the water in the liquid crystal with directly contacting with the liquid crystal. Relative to the traditional dehydration process, the drying way is replayed by the directly contacting way. At the same time, the contacting area between the liquid crystal and the desiccant is enlarged for absorbing the water in the liquid crystal effectually and improving the dehydration effectively. Therefore, the efficiency of the whole liquid crystal process can be improved. In addition, with the preheating of the desiccant, the water can be released from the desiccant by heating. And then the preheated desiccant is applied in the liquid crystal drying, the absorbing effect is better and the dehydration efficiency is improved. The liquid crystal display will not only get a steady Gamma value but also reduce the difference between the gray scale transition and the normal level by means of controlling the moisture content of the liquid crystal.

### DETAILED DESCRIPTION OF THE PREFERRED EMBODIMENTS

For effectively controlling the moisture content in the liquid crystal display, in process of manufacturing, the moisture content should be reduced to avoid the change of the dielectric constant of the liquid crystal and accordingly get a steady voltage and transmissivity curve. The present invention provides a dehydration method for liquid crystal display, wherein comprising the following steps.

In the first embodiment, the dehydration method for liquid crystal display comprises the following steps:

Step 1) leading the liquid crystal into a closed container which filling with desiccant, with desiccant directly contacting to the liquid crystal, the water in the liquid crystal could be absorbed by desiccant to keep the moisture content in the liquid crystal below 25 ppm;

Step 2) leading the dried liquid crystal into a filter to filter and insulate the large size pellets off;

Step 3) deaerating the filtered liquid crystal in the vacuum;

Step 4) leading the deaerated liquid crystal into an infusion equipment, and then pouringing them onto a base by ODF technology.

Before the infusion processing, the liquid crystal will be dried, filtered and deaerated for wiping the water and the large size pellet off the liquid crystal, in order to control the Gamma value of the liquid crystal display to be steady.

In step 1) after spreading, the liquid crystal can be lead into a closely container. The water in the liquid crystal can be fast absorbed with the desiccant directly contacting with the liquid crystal, so that the drying efficiency will be improved and the drying time will be shorten. The liquid crystal can be dried in the closed container for 8-12 hours, preferably, the liquid crystal can be dried for 10 hours. The moisture content of the liquid crystal can be determined by the hygrometer. As the moisture content is below 25 ppm, the drying process is over. As the moisture content is over 25 ppm, the desiccant should be replaced in time.

In the present invention, the desiccant is selected of zeolite molecular sieve or silica gel. There is not ion extraction separated from the silica gel after cleaning. The pure silica gel can be separated from the silicic acid after pickling and alkali washing again and again. And then the silica gel can be produced in high purity hydrochloric acid. The ion extraction is separated from the silica gel to reduce the pollution of the desiccant to the liquid crystal.

In step 2) leading the dried liquid crystal into a filter, the diameter of the filter hole of the filter is 1-5 μm to prevent the large size pellets off into the closely container. Preferably, the diameter of the filter hole of the filter is 1 μm. And then the liquid crystal should be deaerated after filtering.

In step 3) deaerating the filtered liquid crystal in the vacuum. The liquid crystal can be deaerating with heating under 18-27° C. The deaerating time is 0.5-4 hours. The air bubble in the liquid crystal can be wiped off by the deaerating process. In the present embodiment, the pressure of the deaerating is Spa and the deaerating temperature is 25° C. and the deaerating time is 1 hour. If the temperature of the deaerating is too high, the dehydration effect will be not so good. If the temperature of the deaerating is too low, the condensate water will be appeared easily to increase the moisture content in the liquid crystal.

In step 4) leading the deaerated liquid crystal into an infusion equipment, and then pouringing them onto a base by ODF technology.

In the second embodiment, the dehydration method for liquid crystal display further increases the step of pretreating to the desiccative.

The method further comprises step A) before step 1) pretreating the desiccant below 200° C. for 4-5 hours and then cooling it to room temperature. With the pretreating on the desiccant, the desiccant could be adjusted to be the best condition to release the water in the desiccant. The water in the liquid crystal can be fast absorbed with the directly contacting with the liquid crystal. With the directly contacting way, the drying efficiency could be greatly raised and the drying time also could be reduced.

What is claimed is:

1. A dehydration method for liquid crystal display, comprising the following steps:
Step 1) pretreating the desiccant below 200° C. for 4-5 hours and then cooling it to room temperature;
Step 2) leading the liquid crystal into a closed container which filling with desiccant, with desiccant directly contacting to the liquid crystal, the water in the liquid crystal could be absorbed by desiccant to keep the moisture content in the liquid crystal below 25 ppm;
Step 3) leading the dried liquid crystal into a filter to filter and insulate a number of large size pellets off;
Step 4) deaerating the filtered liquid crystal in the vacuum; and
Step 5) leading the deaerated liquid crystal into an infusion equipment, and then pouring the liquid crystal onto a base by ODF technology.

2. The dehydration method for liquid crystal display according to claim 1, wherein in step 1) the desiccant is selected of zeolite molecular sieve or silica gel.

3. The dehydration method for liquid crystal display according to claim 2, wherein in step 1) the liquid crystal can be dried in the closed container for 8-12 hours.

4. The dehydration method for liquid crystal display according to claim 3, wherein in step 1) the liquid crystal can be dried in the closed container for 10 hours.

5. The dehydration method for liquid crystal display according to claim 4, wherein in step 2) the liquid crystal can be leaded into the filer which the diameter of the filer hole is 1-5 μm.

6. The dehydration method for liquid crystal display according to claim 5, wherein in step 3) on the liquid crystal deaerating process, the temperature is 18-27° C. and the deaerating time is 0.5-4 hours.

7. The dehydration method for liquid crystal display according to claim 6, wherein in step 3) during the deaerating of the liquid crystal, the inner pressure is 5 Pa and the deaerating temperature is 25° C. and the deaerating time is 1 hour.

8. A dehydration method for liquid crystal display, comprising the following steps:
Step 1) leading the liquid crystal into a closed container which filling with desiccant, with desiccant directly contacting to the liquid crystal, the water in the liquid crystal could be absorbed by desiccant to keep the moisture content in the liquid crystal below 25 ppm;
Step 2) leading the dried liquid crystal into a filter to filter and insulate the large size pellets off;
Step 3) deaerating the filtered liquid crystal in the vacuum; and
Step 4) leading the deaerated liquid crystal into an infusion equipment, and then pouringing them onto a base by ODF technology.

9. The dehydration method for liquid crystal display according to claim 8, wherein in step 1) the desiccant is selected of zeolite molecular sieve or silica gel.

10. The dehydration method for liquid crystal display according to claim 8, wherein in the closely container, with desiccant directly contacting to the liquid crystal, the water in the liquid crystal could be fast absorbed by desiccant.

11. The dehydration method for liquid crystal display according to claim 10, further comprising step A) before step 1) pretreating the desiccant below 200° C. for 4-5 hours and then cooling it to room temperature.

12. The dehydration method for liquid crystal display according to claim 11, wherein in step 1) the liquid crystal can be dried in the closed container for 8-12 hours.

13. The dehydration method for liquid crystal display according to claim 12, wherein in step 1) the liquid crystal can be dried in the closed container for 10 hours.

14. The dehydration method for liquid crystal display according to claim 12, wherein the liquid crystal can be leaded into the filer which the diameter of the filter hole is 1-5 μm.

15. The dehydration method for liquid crystal display according to claim 12, wherein in step 3) on the liquid crystal deaerating process, the temperature is 18-27° C. and the deaerating time is 0.5-4 hours.

16. The dehydration method for liquid crystal display according to claim 15, wherein in step 3) during the deaerating of the liquid crystal, the inner pressure is 5 Pa and the deaerating temperature is 25° C. and the deaerating time is 1 hour.
